(19) United States
(12) Patent Application Publication
(10) Pub. No.: US 2026/0257557 A1
(43) Pub. Date: Sep. 3, 2026

(54) METHOD AND SYSTEM FOR MEDIA DELIVERY ON A VEHICLE

(71) Applicant: GM GLOBAL TECHNOLOGY OPERATIONS LLC, Detroit, MI (US)

(72) Inventors: Omer Tsimhoni, Bloomfield Hills, MI (US); Ohad Akiva, Kfar Saba (IL); Hadar Geva, Hertzliya (IL); Elior Hadad, Ness Tziona (IL)

(73) Assignee: GM GLOBAL TECHNOLOGY OPERATIONS LLC, Detroit, MI (US)

(21) Appl. No.: 19/068,363

(22) Filed: Mar. 3, 2025

(51) Int. Cl. B60K 35/28; B60K 35/22

(52) U.S. Cl. CPC B60K 35/28; B60K 35/22; B60K 2360/1438; B60K 2360/148; B60K 2360/161; B60K 2360/592

(57) ABSTRACT

The disclosure includes a system having a camera; a media delivery device; a query device; a vehicle-specific digital companion; and a generative media provider. A controller captures, via the query device, an operator input to the query device; determines a configuration of the vehicle; determines a characteristic of the configuration of the vehicle; determines, via the digital companion, an initial response to the operator input to the query device; and generates, via the generative media provider and the digital companion, an adapted response, wherein the adapted response includes the initial response to the operator input to the query device being adjusted based upon the configuration of the vehicle and the characteristic of the configuration of the vehicle.

### INTRODUCTION

On-vehicle information content may be limited due to digital memory availability. In some embodiments, content for a digital owner's manual may be limited to pre-captured images and videos for limited models and for limited orientations of the car. In some instances, virtual assistant answers may not have relevant media for illustrating or describing the content in response to a query from an operator or passenger.

### SUMMARY

The concepts described herein provide an on-vehicle media delivery system for providing content to vehicle operators and/or passengers, in the form of a digital owner’s manual or a digital companion, that employs generative artificial intelligence (AI) technology to generate and display media content to vehicle occupants on an ad hoc basis, wherein the media content is responsive to a query and is specific to the vehicle configuration and vehicle surroundings.

The system described herein is able to adjust the media content to a specific car model, design, and situation that is based on real time input from car sensors. This includes employing generative AI to create media based on real-time and/or historical visual data from the vehicle and/or user feedback.

An aspect of the disclosure may include a system and method to generate visual media in the form of video, images, text, and/or audio that is in response to one or more of text input, a driver monitoring camera, a cabin monitoring camera, an exterior surround view camera, vehicle configuration settings, vehicle-based images and trim-based images.

In one embodiment a speech-based multimodal virtual assistant is arranged to generate ad hoc media (images and videos) that match vehicle content and internal and external temporal context. The media is generated using generative AI and is adapted to the specific vehicle design by using visual inputs from input sensors (e.g., a driver monitoring camera, cabin monitoring cameras, exterior surround view cameras, vehicle configuration settings, vehicle- and trim-based images, digital owner's manual, and screen captures). It is capable of generating content for various features, based on the digital owner's manual, vehicle settings, car configuration, infotainment screens and available application program interfaces (APIs). It is also capable of generating media and visual images for areas that may not be visible directly through the sensors. Users provide feedback for a virtual assistant to update the media and its future responses.

An aspect of the disclosure may include a system that includes a controller in communication with a camera; a media delivery device; a query device; a vehicle-specific digital companion; and a generative media provider. The controller has access to an instruction set stored on a non-transitory processor-readable medium. The instruction set is executable by the controller to: capture, via the query device, an operator input to the query device; determine a configuration of the vehicle; determine, via the camera, a characteristic of the configuration of the vehicle; determine, via the digital companion, an initial response to the operator input to the query device; generate, via the generative media provider and the digital companion, an adapted response, wherein the adapted response includes the initial response to the operator input to the query device being adjusted based upon the configuration of the vehicle and the characteristic of the configuration of the vehicle; and present, via the media delivery device, the adapted response.

Another aspect of the disclosure may include the media delivery device being at least one of a digital screen, an image projector, an audio speaker, and a haptic device.

Another aspect of the disclosure may include the adapted response being arranged based upon the media delivery device.

Another aspect of the disclosure may include the query device being at least one of a digital touchscreen and a digitized voice assistant including a microphone.

Another aspect of the disclosure may include the generative media provider being cloud-based.

Another aspect of the disclosure may include the generative media provider being arranged on-vehicle.

Another aspect of the disclosure may include the generative media provider being a generative artificial intelligence (AI) agent.

Another aspect of the disclosure may include the configuration of the vehicle being object characteristics of at least one of a seat belt, a steering wheel, a driver’s seat, a rearview mirror, a sideview mirror, a head restraint, and a cup holder.

Another aspect of the disclosure may include the characteristic of the configuration of the vehicle being at least one of a color, size, or material of the configuration.

Another aspect of the disclosure may include the digital companion being a digital owner’s manual for the vehicle.

Another aspect of the disclosure may include a system including a controller in communication with a camera; a media delivery device; a query device; a digital companion; and a generative media provider. The controller has access to an instruction set stored on a non-transitory processor-readable medium. The instruction set is executable by the controller to: capture, via the query device, an operator input to the query device; determine a configuration of the vehicle; determine, via the camera, a characteristic of the configuration of the vehicle; determine, via the digital companion, an initial response to the operator input to the query device; generate, via the generative media provider, an adapted response, wherein the adapted response includes the initial response to the operator input to the query device being adjusted based upon the configuration of the vehicle and the characteristic of the configuration of the vehicle; and present, via the media delivery device, the adapted response.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIGS. 1A and 1B pictorially illustrate an interior portion of a vehicle and an external 90 communication system, in accordance with the disclosure.

FIG. 2 schematically illustrates an embodiment of an on-vehicle media delivery system, in accordance with the disclosure.

FIG. 3 schematically illustrates an embodiment of a flowchart associated with an on-vehicle media delivery system, in accordance with the disclosure.

The appended drawings are not necessarily to scale, and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but merely represents possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure.

For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely illustrative in nature and is not intended to limit the application and uses. Furthermore, there is no intention to be bound by an expressed or implied theory presented herein. Throughout the drawings, corresponding reference numerals indicate like or corresponding parts and features.

As employed herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

The use of ordinals such as first, second and third does not necessarily imply a ranked sense of order, but rather may distinguish between multiple instances of an act or structure.

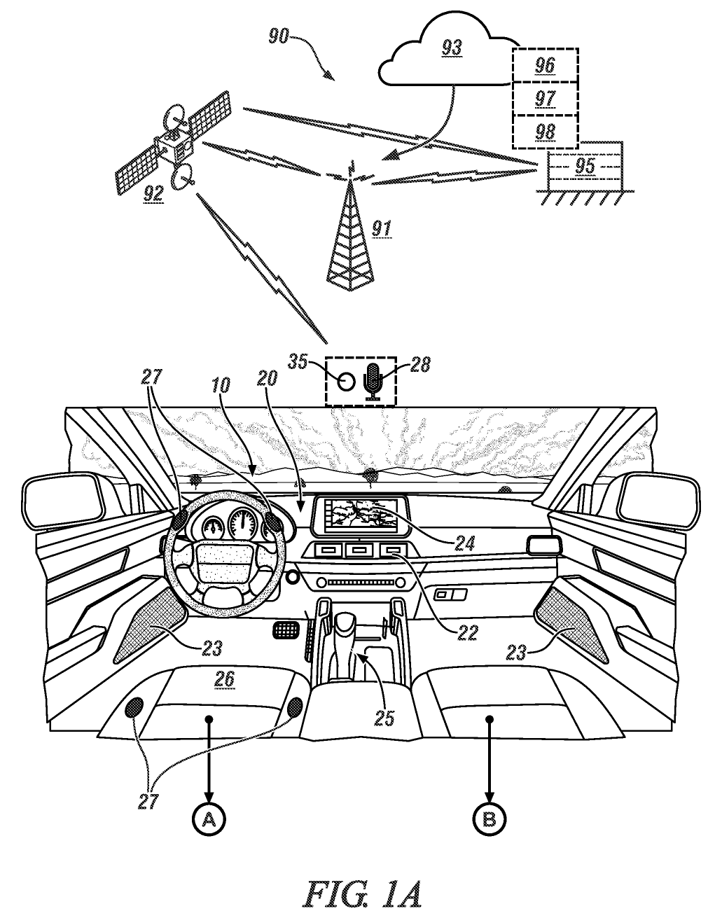

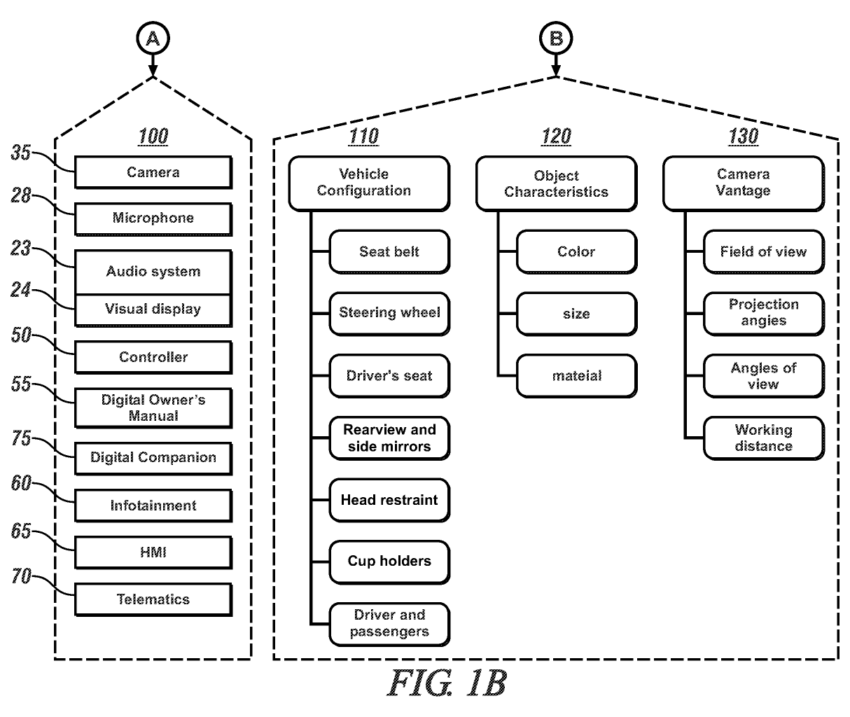

Referring to the drawings, wherein like reference numerals correspond to like or similar components throughout the several Figures, FIGS. 1A and 1B, consistent with embodiments disclosed herein, illustrates a passenger cabin 20 of a vehicle 10 having elements that are arranged to execute an embodiment of an on-vehicle media delivery system 100. The vehicle 10 may include, but not be limited to a mobile platform in the form of a commercial vehicle, industrial vehicle, agricultural vehicle, passenger vehicle, aircraft, watercraft, train, all-terrain vehicle, personal movement apparatus, robot, and the like to accomplish the purposes of this disclosure. The vehicle 10 is disposed on and able to traverse a travel surface such as a paved road surface. The passenger cabin 20 and vehicle 10 provide operator controls 25, controller 50, an infotainment system 60, a human/machine interface (HMI) system 65, and a telematics system 70. The vehicle 10 also includes a digital companion 75. A digital owner’s manual 55 is stored on a memory device that is accessible to the digital companion 75. The digital owner’s manual 55 may be arranged on-vehicle, may be cloud-based, or a combination thereof.

In one embodiment, the vehicle 10 includes a vehicle operating system and one or more of a vehicle monitoring system, an advanced driver assistance system (ADAS) including an exterior view camera, and a navigation system. The vehicle operating system is composed of a propulsion system, a steering system, a braking system, and a suspension system. Operations of the various elements of the vehicle operating system are controlled by one or multiple controllers in response to operator inputs to the operator controls 25.

The passenger cabin 20 includes the operator controls 25, an audio system 22 with one or a plurality of speaker(s) 23 and one or a plurality of microphone(s) 28, a visual display system 24, and driver’s seat 26. One or a plurality of camera(s) 35 may be arranged to visually monitor the passenger cabin 20, including for purposes of driver monitoring and cabin monitoring. In addition, one or a plurality of camera(s) 35 may be arranged to monitor temporal exterior surroundings of the vehicle 10. The microphone(s) 28 may be arranged to audibly monitor the passenger cabin 20. In one embodiment, microphone 28 is arranged to monitor audible sound within the passenger cabin 20 and around the exterior of the vehicle 10. In one embodiment, the driver's seat 26 includes a plurality of haptic devices 27 disposed in a seat bottom and/or a seat back.

The visual display system 24 includes electronic visual display devices, including, e.g., digital screens, touchscreen(s), a liquid crystal display (LCD) device having touch-screen capability, a heads-up display (HUD), etc. The visual display system 24 is arranged as an electronic visual display device that is capable of electronic presentation of still images, text, and/or video in black-and-white and/or color formats. The visual display system 24 may also include one or more of a driver information center, vehicle interior lighting, left and right sideview mirrors, a rear-view mirror, one or multiple digital mirrors, etc. The visual display system 24 may be part of the infotainment system 60 in one embodiment.

The infotainment system 60 includes the visual display system 24, audio devices, haptic devices, and controller(s) that facilitate(s) communication, interaction, and control of various vehicle subsystems, the ADAS, the spatial monitoring system, the navigation system, and the telematics system 70. The HMI system 65 enables an operator to interact with and direct operation of the vehicle 10 in functioning to provide passenger communication, navigation, infotainment, environmental comfort, etc., and to gain access to recessed areas on-vehicle. Operator interface devices may include devices that are capable of transmitting a message.

The HMI system 65 provides for human/machine interaction, for purposes of directing operation of the infotainment system, the navigation system, and the like. The HMI system 65 may be configured as a plurality of controllers and associated sensing devices. Operator interface devices may include devices that are capable of transmitting a message urging operator action, and may include the visual display system 24.

The operator controls 25 may be included in the passenger cabin 20 of the vehicle 10, and may include, by way of non-limiting examples, an accelerator pedal, a steering wheel, a brake pedal, a turn signal indicator, a suspension selection switch, a transmission range selector (PRNDL), a cruise control actuator, an ADAS actuator, a parking brake, and/or other operator-controlled devices. The operator controls 25 may also include an operator interface device that is an element of the infotainment system 60, such as an embodiment of the visual display system 24 that includes a touch screen. The operator controls 25 enable a vehicle operator to interact with and direct operation of the vehicle 10 in functioning to provide passenger transportation, navigation, infotainment, environmental comfort, etc., and to gain access to recessed areas on-vehicle.

The digital companion 75 is a software application that is available on-vehicle via the controller 50 to provide personalized assistance and interaction with a user. The digital companion 75 may also be available via a cell phone, tablet, or other device, without limitation. The digital companion 75 may be vehicle-specific, and is integrated into the vehicle 10 learn driving habits and preferences, provide personalized features, customized settings, recommendations, and assistance through voice commands or a user interface, and function as a smart assistant that is tailored specifically to the vehicle and driving experience. In some embodiments, the digital companion 75 may manage functions such as navigation, climate control, and entertainment, and may provide proactive suggestions based on the driver’s routine and current conditions. The digital companion 75 may interact with the driver through voice commands, allowing hands-free control of various vehicle functions. The digital companion 75 may connect to a smartphone and/or other electronic devices to access information and services like calendar appointments, weather updates, and traffic alerts. The digital companion 75 may anticipate the driver’s needs based on driving patterns, and suggest actions like adjusting the climate control based on the weather or finding nearby charging stations if needed. Depending on the level of technology on the vehicle 10, the digital companion 75 may provide a personalized driving mode, including adjusting settings like steering feel, acceleration, and suspension based on a selected driving style. Depending on the level of technology on the vehicle 10, the digital companion 75 may provide route optimization by suggesting the most efficient route based on real-time traffic conditions and the driver’s schedule. Depending on the level of technology on the vehicle 10, the digital companion 75 may provide entertainment customization by tailoring music playlists, podcasts, and audio settings to the driver’s taste. Depending on the level of technology on the vehicle 10, the digital companion 75 may provide vehicle health monitoring by providing alerts about potential maintenance issues, such as brakes, oil changes, tire wear, etc. Depending on the level of technology on the vehicle 10, the digital companion 75 may provide remote vehicle control, such as locking/unlocking doors, checking fuel levels, and preheating the car remotely via a smartphone app.

The telematics system 70 includes a wireless telematics communication system capable of extra-vehicle communication, including communicating with a communication network 90 having wireless and wired communication capabilities. The telematics system 70 interacts with a communication network 90 to effect communication between the vehicle 10, a remote facility 95, and/or a cloud environment 93. The communication network 90 may include one or more of cellular communication 91, satellite communication 92, and/or another communication technology, without limitation. 96

The extra-vehicle communications may include short-range vehicle-to-vehicle (V2V) communication and/or vehicle-to-everything (V2x) communication, which may include communication with an infrastructure monitor, e.g., a traffic camera. Alternatively, or in addition, the telematics system 70 may include wireless telematics communication systems that are capable of short-range wireless communication to a handheld device, e.g., a cell phone, a satellite phone, or another telephonic device. In one embodiment the handheld device includes a software application that includes a wireless protocol to communicate with the telematics system 70, and the handheld device executes the extra-vehicle communication, including communicating with an off-board server via the wireless communication network. The telematics system 70 may execute extra-vehicle communication by communicating directly with the remote facility 95 via the communication network 90.

The terms “cloud”, “cloud-based”, and related terms may be defined as a model for enabling ubiquitous, convenient, on-demand network access to a shared pool of configurable computing resources (e.g., networks, servers, storage, applications, and services) that may be rapidly provisioned via virtualization and released with minimal management effort or service provider interaction, and then scaled accordingly. A cloud model may be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The term “controller” and related terms such as microcontroller, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component stores machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example each 100 microseconds during ongoing operation. Alternatively, routines may be executed in response to occurrence of a triggering event.

Communication between controllers, actuators and/or sensors on-vehicle may be accomplished using a direct wired point-to-point link, a networked communication bus link, a wireless link, or another suitable communication link, including, e.g., an Ethernet link and a controller area network (CAN) link. Communication includes exchanging data signals in suitable form, including, for example, electrical signals via a conductive medium, electromagnetic signals via air, optical signals via optical waveguides, and the like. The data signals may include discrete, analog, or digitized analog signals representing inputs from sensors, actuator commands, and communication between controllers.

The term "signal" refers to a physically discernible indicator that conveys information, and may be a suitable waveform (e.g., electrical, optical, magnetic, mechanical, or electromagnetic), such as DC, AC, sinusoidal-wave, triangular-wave, square-wave, vibration, and the like, which is capable of traveling through a medium. A parameter is defined as a measurable quantity that represents a physical property of a device or other element that is discernible using one or more sensors and/or a physical model. A parameter may have a discrete value, e.g., either “1” or “0”, or may be infinitely variable in value.

The remote facility 95 and/or the cloud environment 93 include one or multiple controller(s) 96, one or multiple memory device(s) 97, and a generative media provider 98. Stated differently, the controller(s) 96, memory device(s) 97, and generative media provider 98 may be based in, deployed in and/or executed in either or both the remote facility 95 and the cloud environment 93.

The generative media provider 98 employs one or multiple artificial intelligence (AI) algorithms to provide generative media to vehicle occupants, including vehicle-specific information from the digital companion 75 that is adapted to a subject vehicle, e.g., vehicle 10.

Inputs for the generative media provider 98 include vehicle configuration parameters 110, object characteristics 120, and camera vantage parameters 130, which may be specific to the vehicle 10, the external temporal surroundings of the vehicle 10, and the temporal occupants of the vehicle 10.

The vehicle configuration parameters 110 include, by way of non-limiting examples, settings related to the seat belt, steering wheel, driver’s seat, rearview mirrors, sideview mirrors, head restraints, cup holders, child seats (if any), and location(s) position(s) of the driver and passenger(s).

The object characteristics 120 include interior color(s), size(s), and material(s), amongst others.

The camera vantage parameters 130 include fields-of-view, projection angle(s), angle(s) of view, and working distance(s), amongst others.

The generative media provider 98 provides generative media, which refers to digital content in the form of images, videos, text, and/or audio that is created by AI algorithms. The AI algorithms are stored in the memory device(s) 97, and are executed by the controller(s) 96, often in response to a query that is generated via the digital companion 75. The AI algorithms of the generative media provider 98 generate new media based on input prompts or parameters, mimicking human creativity to produce original outputs, where the user, i.e., the vehicle operator provides instructions and the AI creates the content based upon guidelines that may include the digital owner's manual 55, and information from the camera(s) 35.

The concepts described herein provide for incorporating information captured by the camera(s) 35 into images for the digital owner’s manual 55, which may be displayed via the digital companion 75 or another display device. As such, the generated images reflect the interior and/or the exterior of the subject vehicle. The generated images displayed via the digital companion 75 relate to the vehicle interior, including, e.g., interior and exterior colors, environmental parameters such as temperature, humidity, etc., passenger count and location, passenger characteristics, vehicle configuration in real-time, vehicle regular production options (RPOs), languages, etc. The interior and exterior colors include, e.g., the color of interior elements such as the seats and the dashboard, which may be inserted into generated images that contain the interior and/or the exterior of the vehicle. The environmental parameters include, e.g., day, night, and ambient brightness, weather (rain/snow/fog), road color (dark/light). The characteristics of passengers including, e.g., child/adult, short/long hair, and may be used for visual match with content. The vehicle real-time configuration includes third row seating, child seats, seat positions, roof open, towed equipment, charging cable connected, climate settings, buttons status and values, etc. The color of interior elements such as the seats and the dashboard may be inserted into generated images that include the interior and/or the exterior of the vehicle. The RPO may be used to select content according to the content available to the subject vehicle. A camera vantage point may be used to determine driver eye height to create images from the driver’s eyes vantage point.

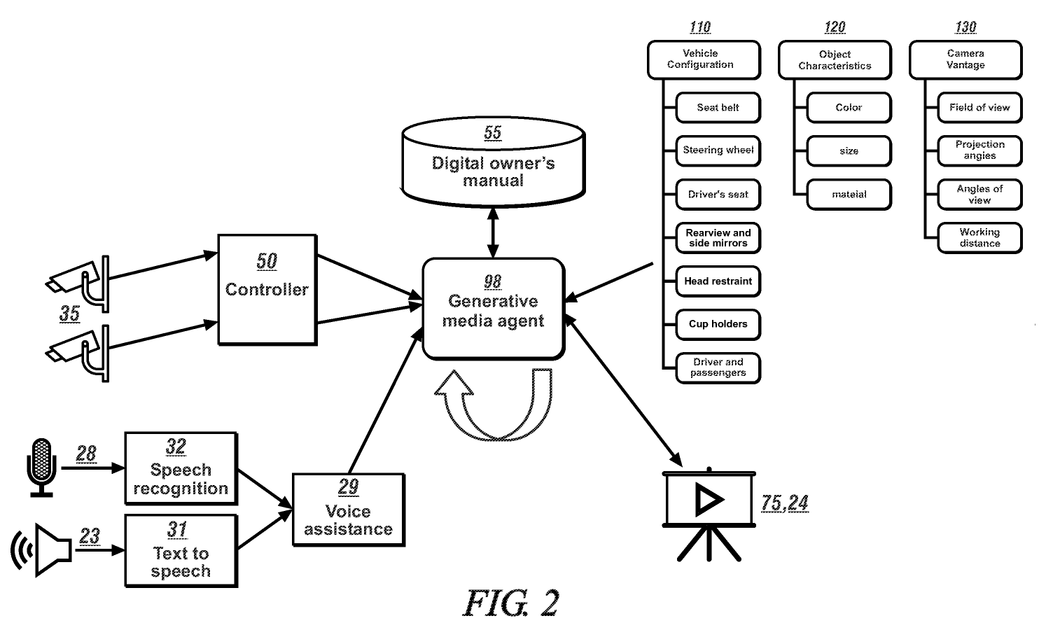

FIG. 2 schematically illustrates details of an embodiment of the on-vehicle media delivery system 100, which may be employed on an embodiment of the vehicle 10 that is described with reference to FIGS. 1A and 1B. Elements of the on-vehicle media delivery system 100 may be stored in and executed on the vehicle 10, in the cloud environment 93, and/or in the remote facility 95. Core elements of the on-vehicle media delivery system 100 include the digital companion 75, which is vehicle-specific and disposed on-vehicle, and the generative media provider 98.

In one embodiment, the on-vehicle media delivery system 100 includes an on-vehicle controller 50 that is in communication with one or multiple camera(s) 35; media delivery devices such as speaker(s) 23, visual display system(s) 24, haptic device(s) 27, etc., one or multiple query device(s) such as microphone(s) 28, a digitized voice assistant 29, a text-to-speech device 31, a speech recognition system 32, and the visual display system 24, which may be a touchscreen in one embodiment. The on-vehicle controller 50 communicates with the extra-vehicle controller(s) 96 via the telematics system 70.

The camera(s) 35, the digitized voice assistant 29, the controller 50, and/or elements of the visual display system 24 provide temporal inputs to the generative media provider 98, which may be combined with the vehicle configuration parameters 110, object characteristics 120, and camera vantage parameters 130. Overall, one of or both of the extra-vehicle controller(s) 96 and the on-vehicle controller 50 has access to an instruction set 300 stored on a non-transitory processor-readable medium such as memory device(s) 97. The instruction set is executable by the controller 50 to capture, via one or more of the query device(s) such as microphone(s) 28, digitized voice assistant 29, text-to-speech device 31, and the visual display system 24, an operator input requesting information; determine a configuration of the subject vehicle 10; determine, via the camera(s) 35, one or more characteristics of the configuration of the vehicle and the temporal surroundings; determine, via the digital companion 75, an initial response to the operator input to the query device; generate, via the generative media provider 98, the digital owner’s manual 55, and the digital companion 75, an adapted response, wherein the adapted response includes the initial response to the operator input to the query device being adjusted based upon the configuration of the vehicle and the characteristic of the configuration of the vehicle and the temporal surroundings; and present the adapted response via the media delivery device(s) in the form of one or more of the digital companion 75, the visual display system 24, and/or the speaker(s) 23. The adapted response may be presented in one or more of a visual medium, an audible medium, and a haptic medium.

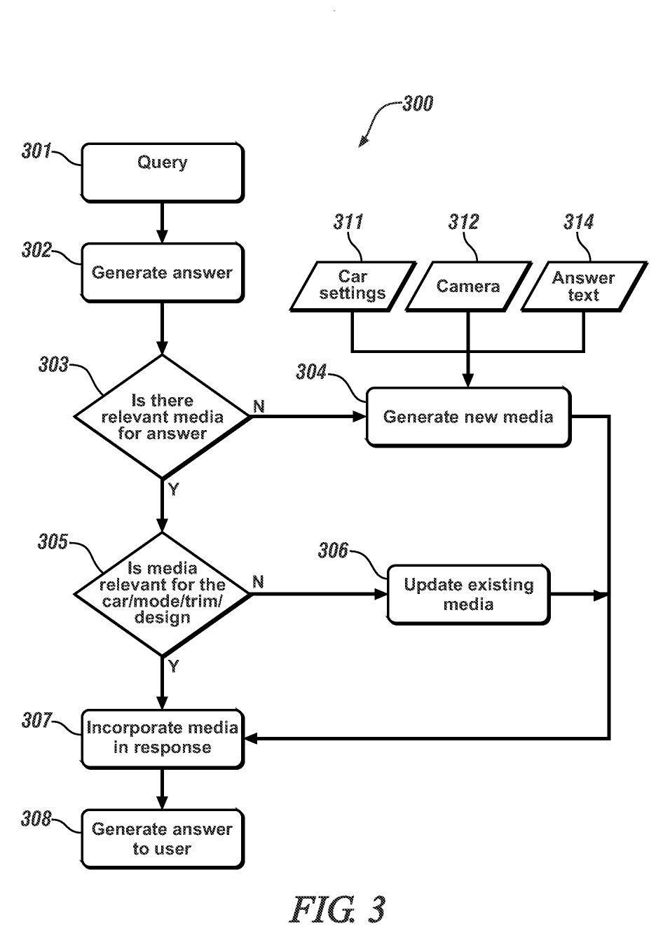

FIG. 3 schematically illustrates an instruction set 300 that is in the form of a flowchart. The instruction set 300 is associated with the on-vehicle media delivery system 100 described with reference to FIG. 2, and is executed for a subject vehicle, an embodiment of which is described with reference to FIG. 3. Execution of the instruction set 300 is initiated by a query from the operator or other occupant of the vehicle to the digital owner’s manual (Step 301). The query may be in the form of a verbal/spoken request via microphone 28, a text request via a screen, or another input from the operator. A query may be explicit, or it may be implicit, such as when an occupant appears, via the camera 35, to be searching for something.

The on-vehicle media delivery system 100 may generate an initial answer (Step 302), or may ask for more information from the operator to select the initial response.

The on-vehicle media delivery system 100 determines if there is existing media to generate a final response (Step 303).

When there is no existing media to generate a final response (Step 303)(N), the on-vehicle media delivery system 100 employs the generative media provider 98 to generate new media based upon extant, temporal vehicle settings 311, camera settings and information 312, and textual inputs 314 (Step 304).

When there is existing media to generate a final response (Step 303)(Y), the on-vehicle media delivery system 100 determines if the existing media has been attuned to relevant parameters of the subject vehicle, including, e.g., model, trim level, design features, etc. (Step 305).

When the existing media has not been attuned to relevant parameters of the subject vehicle, including, e.g., model, trim level, design features, etc. (Step 305)(N), the existing media is updated to incorporate the relevant parameters of the subject vehicle (Step 306).

The existing media is incorporated into an adapted response (Step 307), which is employed to generate an answer that is presented and/or delivered to the occupant, i.e., the vehicle driver and/or vehicle passenger(s) (Step 308). The adapted response is presented via the media delivery device(s) in the form of one or more of the digital companion 75, the visual display system 24, and/or the speaker(s) 23.

In this manner, an answer to a user request for owner's manual related questions is generated in a manner that is specific to the subject vehicle, and is adapted to account for and accommodate temporal information.

By way of a non-limiting example, the on-vehicle media delivery system 100 may be queried about details related to changing a tire due to a low tire pressure event on one of the subject vehicle’s corners. The query may be generated by a vehicle occupant, or alternatively, the query may be generated by the controller 50 upon receiving input from a tire pressure monitoring system indicating occurrence of a low tire pressure event. The on-vehicle media delivery system 100 may employ the camera(s) 35 to monitor the temporal interior and exterior portions of the vehicle 10. The digital owner’s manual 55 may be queried to identify relevant elements related to changing a tire, such as on-vehicle locations of a tire jack, a wrench, and a spare tire; jacking locations on the exterior of the vehicle; precautions such as setting a parking brake; etc. The generative media provider 98 may incorporate information in the form of the vehicle configuration parameters 110, object characteristics 120, and camera vantage parameters 130, query the digital owner’s manual 55, and generate up-to-date temporal information that may be displayed via the visual display system 24 that depicts locations of the tire jack, wrench, and spare tire, jacking locations, and the affected corner of the subject vehicle that has been adapted to the specific details and features of the subject vehicle in its present location and surroundings.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that may direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A media delivery system for a vehicle, comprising:
a controller in communication with a camera;
a media delivery device;
a query device;
a vehicle-specific digital companion; and
a generative media provider;
the controller having access to an instruction set stored on a non-transitory processor-readable medium, the instruction set being executable by the controller to:
capture, via the query device, an operator input to the query device;
determine a configuration of the vehicle;
determine, via the camera, a characteristic of the configuration of the vehicle;
determine, via the digital companion, an initial response to the operator input to the query device;
generate, via the generative media provider and the digital companion, an adapted response, wherein the adapted response includes the initial response to the operator input to the query device being adjusted based upon the configuration of the vehicle and the characteristic of the configuration of the vehicle; and
present, via the media delivery device, the adapted response.

2. The system of claim 1, wherein the media delivery device comprises at least one of a digital screen, an image projector, an audio speaker, and a haptic device.

3. The system of claim 2, wherein the adapted response is arranged based upon the media delivery device.

4. The system of claim 1, wherein the query device comprises at least one of a digital touchscreen and a digitized voice assistant including a microphone.

5. The system of claim 1, wherein the generative media provider is cloud-based.

6. The system of claim 1, wherein the generative media provider is arranged on-vehicle.

7. The system of claim 1, wherein the generative media provider comprises a generative artificial intelligence (AI) agent.

8. The system of claim 1, wherein the configuration of the vehicle comprises object characteristics of at least one of a seat belt, a steering wheel, a driver’s seat, a rearview mirror, a sideview mirror, a head restraint, and a cup holder.

9. The system of claim 1, wherein the characteristic of the configuration of the vehicle comprises at least one of a color, size, or material of the configuration.

10. The system of claim 1, wherein the digital companion comprises a digital owner’s manual for the vehicle.

11. An on-vehicle media delivery system, comprising:
a controller in communication with a camera;
a media delivery device;
a query device;
a digital companion; and
a generative media provider;
the controller having access to an instruction set stored on a non-transitory processor-readable medium, the instruction set being executable by the controller to:
capture, via the query device, an operator input to the query device;
determine a configuration of the vehicle;
determine, via the camera, a characteristic of the configuration of the vehicle;
determine, via the digital companion, an initial response to the operator input to the query device;
generate, via the generative media provider, an adapted response, wherein the adapted response includes the initial response to the operator input to the query device being adjusted based upon the configuration of the vehicle and the characteristic of the configuration of the vehicle; and
present, via the media delivery device, the adapted response.

12. The system of claim 11, wherein the media delivery device comprises at least one of a digital screen, an image projector, an audio speaker, and a haptic device.

13. The system of claim 12, wherein the adapted response is arranged based upon the media delivery device.

14. The system of claim 11, wherein the query device comprises at least one of a digital touchscreen and a digitized voice assistant including a microphone.

15. The system of claim 11, wherein the generative media provider is cloud-based.

16. The system of claim 11, wherein the generative media provider is arranged on-vehicle.

17. The system of claim 11, wherein the generative media provider comprises a generative artificial intelligence (AI) agent.

18. The system of claim 11, wherein the configuration of the vehicle comprises object characteristics of at least one of a seat belt, a steering wheel, a driver’s seat, a rearview mirror, a sideview mirror, a head restraint, and a cup holder.

19. The system of claim 11, wherein the characteristic of the configuration of the vehicle comprises at least one of a color, size, or material of the configuration.

20. A method for on-vehicle media delivery, the method comprising:
capturing, via a query device, an operator input;
determining a configuration of the vehicle;
determining, via a camera, a characteristic of the configuration of the vehicle;
determining, via a digital companion, an initial response to the operator input to the query device;
generating, via a generative media provider, an adapted response, wherein the adapted response includes the initial response to the operator input to the query device being adjusted based upon the configuration of the vehicle and the characteristic of the configuration of the vehicle; and
presenting, via the on-vehicle media delivery device, the adapted response.
